(19) United States
(12) Patent Application Publication
(10) Pub. No.: US 2020/0154802 A1
(43) Pub. Date: May 21, 2020

(54) LAMINATED CONSTRUCT

(71) Applicant: JOSEPH CLEARY DOLCETTI, KUALA LUMPUR (MY)

(72) Inventor: JOSEPH CLEARY DOLCETTI, KUALA LUMPUR (MY)

(21) Appl. No.: 16/747,822

(22) Filed: Jan. 21, 2020

Related U.S. Application Data
(63) Continuation-in-part of application No. 15/318,179, filed on Dec. 12, 2016.

(30) Foreign Application Priority Data
Jun. 11, 2014 (MY) PI2014701553

(51) Int. Cl. A41D 31/102; B32B 5/06; B32B 5/08; B32B 25/10; B32B 25/12; B32B 25/14; A41D 31/30

(52) U.S. Cl. CPC A41D 31/102; B32B 5/06; B32B 5/08; B32B 25/10; B32B 25/12; B32B 2309/105; A41D 31/305; B32B 2437/00; B32B 2307/726; B32B 2307/54; B32B 25/14

(57) ABSTRACT

A laminated construct for fabricating a clothing of a user comprising: an outer layer having a plush surface formed with a multitude of loops for establishing a hook and loop connection with an article with hook and loop fasteners; an inner layer formed by any one or a combination of nylon, spandex, polyester, cotton and wool; and an intermediate layer being a natural or synthetic rubber disposed in between the outer layer and inner layer; wherein at least one of the layers is formed with perforations; and the construct is omnidirectionally stretchable and has a tensile strength in a range of 0.5 to 6 N/mm² to hold the article with a total load of not more than 15% of the user's body weight.

### CROSS-REFERENCE TO RELATED APPLICATIONS

The instant application is a continuation in part of U.S. patent application Ser. No. 15/318,179 filed Dec. 12, 2016, pending, is a national phase of PCT International Patent Application Serial No. PCT/MY2015/050021 filed Apr. 1, 2015, and claims priority to Malaysian Patent Application Serial No. PI2014701553 filed Jun. 11, 2014, the entire specifications of all of which are expressly incorporated herein by reference.

### FIELD OF THE INVENTION

This invention relates to laminated constructs, particularly for use as materials for making clothing, especially exercise wear and sportswear, and more especially, exercise and sports training wear.

### BACKGROUND OF THE INVENTION

Exercise wear and sportswear exists in many forms depending on the activity involved. For some activities, such as golf, ordinary casual clothing can be worn but for other sporting or training activities, such as military exercise training, martial arts, weight training and many other sport-playing or training activities, it is desirable that specially designed clothing and clothing materials are used. For the purposes of this specification, the word “clothing” is to be understood as referring not only to complete clothing but also to parts of clothing, such as arm, leg, head and neck coverings.

While attempts have been made to idealise the properties of laminated constructs used to make the clothing, no laminated construct has so far been available that has the properties to make it universally suitable for a wide range of application exercise wear and sportswear. A suitable laminated construct for the manufacturing of clothing used as exercise wear and sportswear should be flexible and compressible to ease movement of the user. Conventional laminated constructs used for clothing catered for exercise and sports are usually made breathable for enabling air vapor to circulate around the body to keep the body cool. However, breathability is overfocused such that the laminated construct becomes unsuitable for use under cold temperature conditions to keep users warm.

In addition, clothing that allows attachments of articles, especially articles with a considerable load such as electronic devices including phones, music players, medical devices, and fitness monitoring devices, should be made of laminated constructs that are strong enough to support the load without dragging the clothing out of shape. However, clothing made for exercise and sporting activities are ideally low in thickness to permit flexible body movement of the user. However, conventional thin laminated constructs have low structural integrity such that it breaks or deforms easily without being able to hold the article.

With an electronic device being attached to the laminated construct, heat generated from the device can easily reach the skin of the user, especially through porous layers of the laminated construct. On the other hand, heat from tools intended for keeping the user warm, such as heat patches disposed underneath the laminated construct, can easily escape through the porous layers of the laminated construct, thereby causing ineffectiveness of the heat patches. While laminated constructs are formed with perforations to achieve breathability, the perforations allow heat transfer of electronic devices or warming tools that cause the abovementioned issues.

There is hence a need to introduce a solution to the drawbacks and limitations of existing klaminated constructs that are intended for exercise wear and sportswear applications.

### SUMMARY OF THE INVENTION

This invention provides a laminated construct that fulfills the desired requirements of clothing, in particular exercise wear and sportswear that includes shirts, vests, shorts, pants, upper arm sleeves, lower arm sleeves, thigh sleeves, leg sleeves, and combinations thereof. However, the clothing made of the laminated construct is not limited to human use. It is also applicable for animals. One of the main objects of this invention is to provide a laminated construct that enables attachment of articles on its surface, especially articles with a considerable load such as mobile phones, fitness and health monitoring devices, music players, exercise weight loads and wallets. In order for the laminated construct to hold these articles, the laminated construct possesses high integrity and is durable such that it is suitable for holding the articles without dragging clothing made of the laminated construct out of shape. The invention disclosed herein introduces a strong laminated construct without requiring a thick laminated construct. The invention introduces a strong laminated construct that is low in thickness. The thin laminated construct improves comfortability of users wearing clothing made of the laminated construct as it is not bulky and heavy, enhances flexibility and eases perforations to be formed in the laminated construct.

Another object of the invention is to provide a laminated construct with elasticity and flexibility to ease movement of the user. Specifically, the laminated construct is made of materials with good pliability such that a piece of clothing made of the laminated construct can be worn in a generally snug fit fashion. Such clothing in its contracting state can apply a compressive force onto a body part that promotes several positive responses including, but not limited to, favorable blood flow, enhanced muscle contraction, improved stabilization and confidence during movement, and a positive thermogenic effect in the specific areas of the body. Further, the compressive strength of the laminated construct offers excellent impact resistance for protection purpose. Articles with impact absorbing properties and a soft or hardened shield-like device can also be attached on the laminated constructed and used to render additional protection to the wearer of the clothing.

Besides that, the laminated construct is intended for fabricating all season clothing. It can be used to make clothing suitable for use under cold or warm temperature conditions while maintaining breathability of the laminated construct. In addition, the invention provides a laminated construct with a heat insulation function to reduce, if not prevent, transfer of heat generated by electronic devices attached on the laminated construct, or heat from heat patches placed underneath the laminated construct and on the skin of the user's body for keeping the user warm. Further, another purpose of the invention is to provide a laminated construct with moisture wicking and water-resistant function to minimize or prevent water and moisture from reaching the skin of the user. It is also an aim of the invention to provide a laminated construct with antimicrobial properties and which is also non-allergenic to prevent undesirable skin effects.

At least one of the preceding objects is met, in whole or in part, by the present invention, in which one of the embodiments of the present invention provides a laminated construct for fabricating a clothing of a user that comprises: an outer layer having a plush surface formed with a multitude of loops for establishing a hook and loop connection with an article with hook and loop fasteners; an inner layer formed by any one or a combination of nylon, spandex, polyester, cotton and wool; and an intermediate layer being a natural or synthetic rubber disposed in between the outer layer and inner layer; wherein at least one of the layers is formed with perforations; and the construct is omnidirectionally stretchable and has a tensile strength of 0.5 to 6 N/mm² to hold the article with a total load of not more than 15% of the user's body weight.

In a preferred embodiment, the laminated construct has a tear strength of 12 to 38 N/mm.

According to a preferred embodiment, the intermediate layer is a closed cell natural or synthetic rubber.

Preferably, the intermediate layer is neoprene or polyurethane.

It is preferred that the plush surface is made of unbroken loop fabric.

In addition, it is preferred that the inner layer has moisture wicking and antimicrobial properties.

Preferred thickness of each layer of the laminated construct is as follows: the outer layer has a thickness of 0.5 to 7 mm; the inner layer has a thickness of less than 3 mm; and the intermediate layer has a thickness of 0.2 to 7 mm.

Further, the laminated construct has a compressive force of 2 to 50 mm Hg.

Based on the preferred embodiment, the perforations are in a range of 0.5 to 5 mm wide.

The perforations are preferred to be spaced apart from one another in a range of 1 to 15 mm.

Preferably, either one or both of the outer layer and intermediate layer are formed with the perforations.

Preferred clothing fabricated by the laminated construct includes a shirt, vest, shorts, pants, upper arm sleeve, lower arm sleeve, thigh sleeve, leg sleeve, and combinations thereof.

### BRIEF DESCRIPTION OF THE DRAWINGS

This invention will now be described in greater detail with reference to the accompanying drawings.

FIG. 1 is an exploded schematic view of the laminated construct showing the different layers of the construct without any perforations.

FIG. 1a is a detailed view of the laminated construct showing the plush surface of the outer layer.

FIG. 2 is an exploded schematic view of the laminated construct showing the outer layer being perforated.

FIG. 3 is an exploded schematic view of the laminated construct showing the intermediate layer being perforated.

FIG. 4 is an exploded schematic view of the laminated construct showing the inner layer being perforated.

FIG. 5 is an exploded schematic view of the laminated construct showing the outer layer and intermediate layer being perforated.

FIG. 6 is an exploded schematic view of the laminated construct showing the outer layer and inner layer being perforated.

FIG. 7 is an exploded schematic view of the laminated construct showing the intermediate layer and inner layer being perforated.

FIG. 8 is an exploded schematic view of the laminated construct showing all the layers being perforated.

FIG. 9 shows a schematic view of a piece of clothing made of the laminated construct having articles attached on the outer layer of the laminated construct.

FIG. 10 shows a detailed schematic view of a piece of clothing showing the articles attached on the plush surface of the outer layer through connections established by the hook and loop fasteners on the surface of the articles and the loops on the plush surface of the outer layer.

### DETAILED DESCRIPTION OF THE INVENTION

For a better understanding of the invention, preferred embodiments of the invention that are illustrated in the accompanying drawings will be described in detail.

Disclosed herein is a laminated construct 100 for fabricating an item of clothing of a user. It is understood that the term ‘clothing’ refers not only to complete clothing but also to anything that can be worn on or wrapped around the entire human body or a part thereof, such as arm, leg, head and neck for covering different body segments of the user. The clothing includes, but not limited to, a shirt, vest, shorts, pants, upper arm sleeve, lower arm sleeve, thigh sleeve, leg sleeve, and combinations thereof. The user of the clothing can be by a human or an animal.

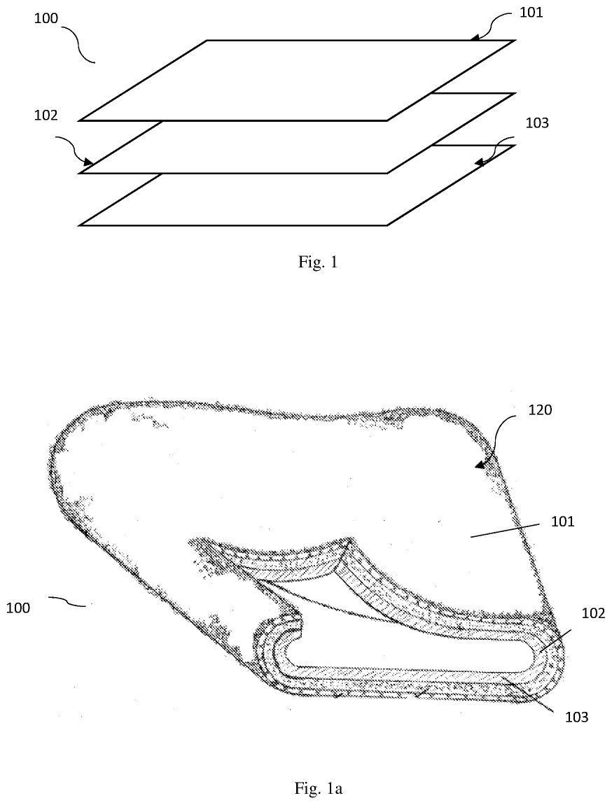

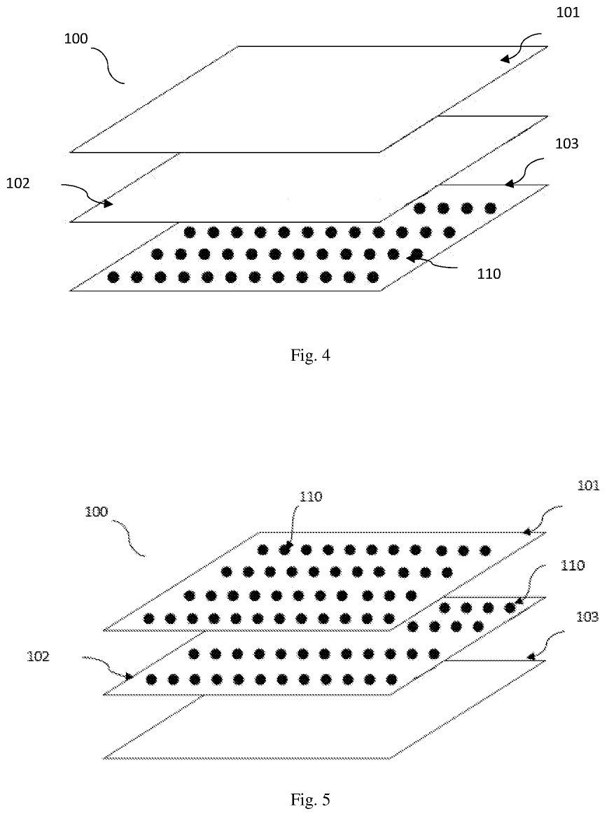

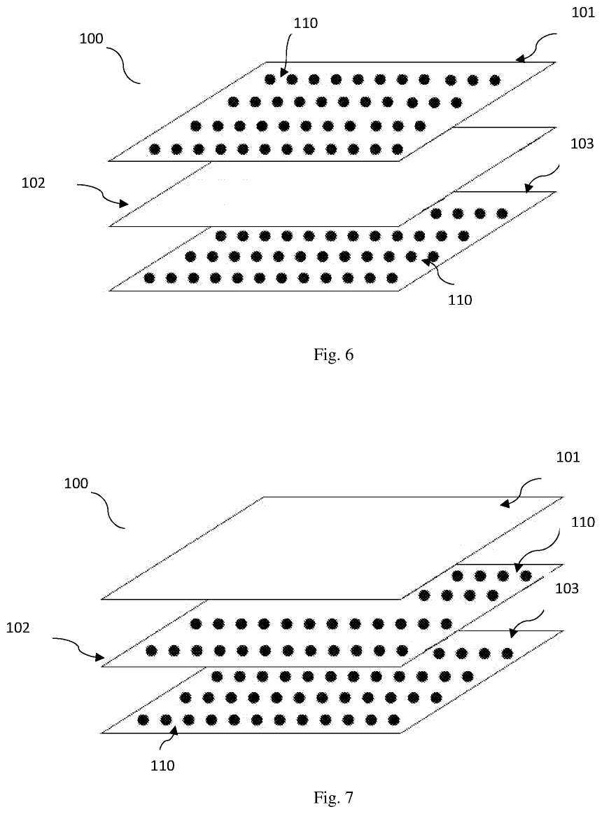

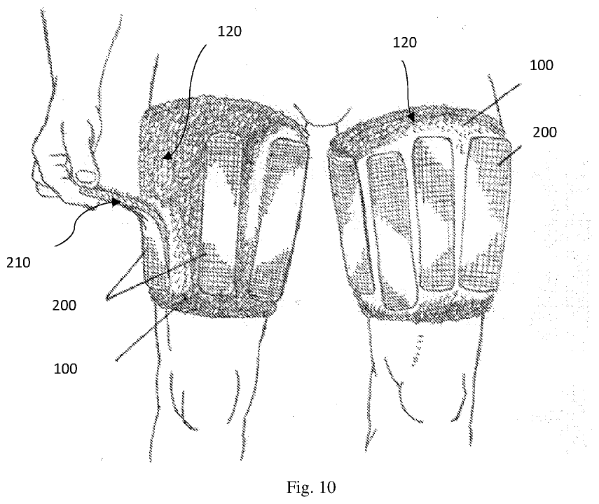

Referring to FIGS. 1-8, the laminated construct 100 comprises at least three layers including an outer layer 101, an inner layer 103 and an intermediate layer 102 sandwiched between the outer layer 101 and the inner layer 103. The outer layer 101 is substantially made of a plush material as shown in FIG. 1a. In particular, the outer layer 101 has a plush surface formed with a multitude of loops 120 for establishing a hook and loop connection with one or more articles 200 with hook and loop fasteners 210 as illustrated in FIG. 10. However, the plush material described herein does not include the loop fasteners of materials that are neither elastic nor stretchable, both of these properties being required in the present invention to permit flexible movement of the user's body. Preferably, the plush surface is made of a soft, smooth and/or silky material and supports attachment of articles on its external surface which is the plush surface. An example of such plush material is an unbroken loop fabric, where the fabric has a pile that is left uncut to form loops 120 on the face of the fabric to be engaged with hook and loop fasteners 210. The unbroken loop (UBL) fabric is a soft but strong material. Moreover, the plush material used in the present invention is a non-irritating fabric to avoid skin irritation. The outer layer 101 preferably has a thickness in a range of 0.5-7 mm, more preferably in a range of 1-5 mm, and most preferably in a range of 2-3 mm.

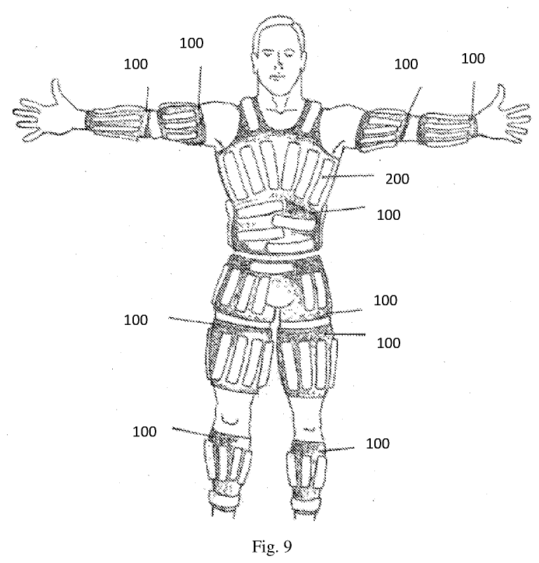

Exemplary articles 200 include training weights, wallets, bio sensors for heart rate, force, speed, calorific output, or acceleration, pedometers, inertia gauges, GPS units, protective padding for various body parts, such as soccer shin guards, or personal music or communication devices. These articles 200 can be encased within a pouch or the like that is included as part of the article 200 with hook and loop fasteners attachable to the plush surface of the outer layer. The laminated construct 100 used for fabricating the clothing can hold one or more articles 200 with a total load of not more than 15% of the body weight of the user. FIG. 9 illustrates an example of a clothing made of the laminated construct 100, having articles 200 attached on the outer layer 101 of the laminated construct 100.

A natural or synthetic rubber applied as an intermediate layer 102 is disposed in between the outer layer 101 and inner layer 103. Although the natural or synthetic rubber can be of open cells, it is preferred that closed cell natural or synthetic rubber is utilized. Examples of applicable intermediate layer 102 include neoprene and polyurethane that offer high pliable and mechanically strong structure. The intermediate layer 102 plays an important role in the structural integrity of the laminated construct 100. Without the intermediate layer 102, the user may find the laminated construct 100 and/or clothing fabricated therefrom, especially the sleeves, slide up or down or even fold due to the body's movement. The intermediate layer 102 protects the user from abrasive injuries and reinforces the body parts. Therapeutic compressive force can be evenly applied to the body parts via the intermediate layer 102. These functions of the intermediate layer are enhanced with the use of closed cell natural or synthetic rubber. Closed cells enhance structural integrity of the intermediate layer 102 as they are strong, with high compressive strength for great impact resistance, durable and less vulnerable to surface damage, thereby making closed cells intermediate layer 102 suitable for facilitating the holding of articles 200 with a load at the outer surface of the laminated construct 100 and also clothing made from the laminated construct 100, without dragging the laminated construct or clothing out of shape.

Further, it is preferred that the intermediate layer 102 possesses a water-resistant feature. The water-resistant nature of a closed cell intermediate layer 102 makes it applicable as a vapor barrier to reduce or prevent water and moisture from getting into the inner layer 103 and the skin of the user. Because the article 200 can be devices that generate heat, with the intermediate layer 102 having a heat insulation feature, heat generated from the device placed on the outer layer 101 will not affect the skin of the user. Similarly, if a tool for keeping the body warm, such as a heat patch, is placed underneath the laminated construct 100, heat can be retained underneath the laminated construct 100 to keep the user warm, without the heat escaping from the laminated construct 100. Such a heat insulation feature is made possible by applying a closed cell intermediate layer 102 that reduces, if not prevents, heat from being transferred through the outer layer 101 into the inner layer 103 and reaching the skin, or through the inner layer 103 into the outer layer and escaping to the outer environment. The intermediate layer 102 may vary in thickness depending on the purpose for which the material is to be used. However, the thickness of the intermediate layer 102 is preferred to be in a range of 0.2-7 mm, more preferably in a range of 0.5-5 mm, and most preferably in a range of 1-3 mm.

Although the inner layer 103 can be any woven or knitted material, it is preferred that the inner layer 103 is formed by any one or a combination of nylon, spandex, polyester, cotton and wool, and most preferably a nylon and spandex blend. Because the inner layer 103 is intended to be in contact with the skin of the user, the inner layer 103 is formed to possess inherent anti-microbial properties and moisture wicking properties, or treated to have such properties. Its thickness is preferably less than 3 mm, more preferably less than 2 mm, and most preferably in a range of around 0.2-1.5 mm. The laminated construct 100 is formed by stitching the three different layers together or laminating them using adhesive, heat, pressure or any combination thereof. According to the thickness stated above for the outer layer 101, intermediate layer 102 and inner layer 103 respectively, the laminated construct 100 is thin to offer comfortability and flexibility to the users. Clothing made of the laminated construct 100 that is low in thickness makes movement of the user easy. Therefore, it is suitable to be used for exercise and sporting activities. Most importantly, the thickness of the outer layer 101, intermediate layer 102 and inner layer 103 results in an overall low thickness for the laminated construct 100, yet such thickness is sufficient for supporting articles 200 attached thereon. The strength of the laminated construct 100 is not compromised by having a low thickness.

In order to hold the article 200 with a significant load on the outer layer 101 of the laminated construct 100, especially with a total load of 15% or less, more preferably with a total load of 10% or less, of the user's body weight, the laminated construct 100 has a tensile strength in a range of 0.5-6 N/mm², more preferably in a range of 1.2-4.3 N/mm², and most preferably in a range of 2-3 N/mm².

Such tensile strength allows the laminated construct 100 that tends to elongate to withstand loads of the articles 200. This is especially important for clothing made of the laminated construct 100 that is catered for exercise and sporting activities. For example, articles 200 such as health and fitness devices, as well as portable music players and phones, can be directly attached to, or held within pouches attached to the clothing while the user exercises without having to manually hold the articles 200 for fear that the articles 200 would unintentionally detach from the clothing. Further, the laminated construct 100 has a tear strength in a range of 12-38 N/mm, more preferably in a range of 14.5-36.5 N/mm, and most preferably in a range of 16-34 N/mm to resist the effects of tearing. Durability of the laminated construct 100 can be ensured with such a tear strength.

The laminated construct 100 is made of materials with elastic properties to provide flexibility and allow it to be omnidirectionally stretchable. In addition, the laminated construct 100 is compressible to increase freedom of movement of the user. Clothing made of the laminated construct 100, when in its contracting state, enables a compressive force to be exerted onto a body part that promotes positive responses including, but not limited to, favorable blood flow, enhanced muscle contraction, improved stabilization and confidence during movement, and a positive thermogenic effect in the specific areas of the body. The clothing made from the laminated construct 100 should provide a compression effect while still being functional and easy to put on and take off and move around in comfortably. Preferably, the laminated construct 100 has a compressive force in a range of 2-50 mm Hg, more preferably in a range of 4-40 mm Hg, and most preferably in a range of 6-30 mm Hg.

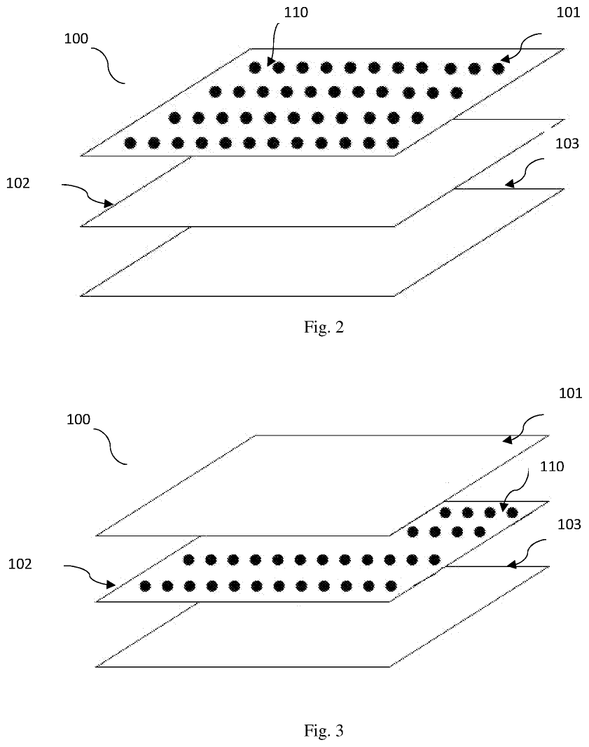

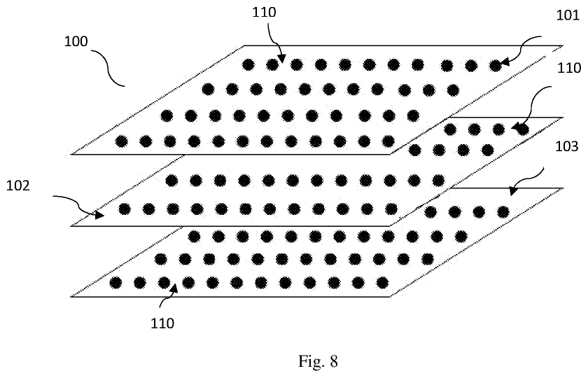

According to an embodiment of the invention, at least one layer of the laminated construct 100 is perforated. A plurality of through holes 110 are punctured through at least one of the layers. The presence of the through holes 110 promotes air ventilation to the surface where the laminated construct 100 is applied, such as the skin if the laminated construct 100 is made into clothing. In addition, perforation also makes the laminated construct 100 lighter weight wise. Each of the through holes 110 may be in a range of 0.5-5 mm in diameter, and preferably within 1.5-4 mm and spaced apart in a predetermined distance in a range of 1-15 mm, more preferably in a range of 3-12 mm, and most preferably in a range of 5-9 mm. The through holes 110 of the clothing made of the laminated construct 100 may be fabricated smaller in size and stretched to the desired dimension upon wearing of the clothing. With at least one layer of the laminated construct 100 being perforated, it should be appreciated that the laminated construct 100 can also have all three layers perforated as shown in FIG. 8, two layers perforated as shown in FIGS. 5-7, or just one layer perforated as shown in FIGS. 2-4. With all three layers perforated as illustrated in FIG. 8, maximum breathability can be achieved as air ventilation is promoted, thereby making the laminated construct 100 suitable to be used in warmer climates. The perforations of one layer can be made to align with those of another layer with perforations, or they can be offset to one another of another layer with perforations. However, in colder climates where heat retention is important, it is not necessary to have all three layers perforated. For example, FIG. 1 depicts an embodiment of the laminated construct without being perforated. The laminated construct 100 can have any two or one of the layers being perforated for preserving heat to keep the user warm. In a preferred embodiment for use in colder climates, as shown in FIG. 5, the outer layer 101 and intermediate layer 102 are perforated to provide breathability and lightness to the laminated construct 100 while the inner layer 101 is not perforated for preserving heat, especially the temperature of the user wearing the clothing made of the laminated construct 100.

Although the description above contains many specifications, it is understood that the embodiments of the preferred form are not to be regarded as a departure from the invention and it may be modified within the scope of the appended claims.

What is claimed is:

1. A laminated construct for fabricating a piece of clothing of a user, comprising:
an outer layer having a plush surface formed with a plurality of loops for establishing a hook and loop connection with an article with hook and loop fasteners;
an inner layer formed by any one or a combination of nylon, spandex, polyester, cotton and wool; and
an intermediate layer being a natural or synthetic rubber disposed in between the outer layer and inner layer;
wherein at least one of the layers is formed with perforations; and
wherein the construct is omnidirectionally stretchable and has a tensile strength in a range of 0.5 to 6 N/mm² to hold the article with a total load of not more than 15% of the user's body weight.

2. The laminated construct according to claim 1, wherein the laminated construct has a tear strength in a range of 12 to 38 N/mm.

3. The laminated construct according to claim 1, wherein the intermediate layer is a closed cell natural or synthetic rubber.

4. The laminated construct according to claim 1, wherein the intermediate layer is neoprene or polyurethane.

5. The laminated construct according to claim 1, wherein the plush surface is made of unbroken loop fabric.

6. The laminated construct according to claim 1, wherein the inner layer has moisture wicking and antimicrobial properties.

7. The laminated construct according to claim 1, wherein the outer layer has a thickness in a range of 0.5 to 7 mm.

8. The laminated construct according to claim 1, wherein the inner layer has a thickness of less than 3 mm.

9. The laminated construct according to claim 1, wherein the intermediate layer has a thickness in a range of 0.2 to 7 mm.

10. The laminated construct according to claim 1, wherein the construct has a compressive force in a range of 2 to 50 mm Hg.

11. The laminated construct according to claim 1, wherein the perforations have a diameter in a range of 0.5 to 5 mm.

12. The laminated construct according to claim 1, wherein the perforations are spaced apart from one another in a range of 1 to 15 mm.

13. The laminated construct according to claim 1, wherein either or both the outer layer and intermediate layer are formed with the perforations.

14. The laminated construct according to claim 1, wherein the piece of clothing includes any one of a shirt, vest, shorts, pants, upper arm sleeve, lower arm sleeve, thigh sleeve and leg sleeve.
